(19) United States
(12) Patent Application Publication
(10) Pub. No.: US 2010/0141013 A1
(43) Pub. Date: Jun. 10, 2010

(54) Coal burning methods & apparatus

(76) Inventor: Roy Jeremy Lahr, West Hollywood, CA (US)

Correspondence Address: Roy J. Lahr, 944 Hommond Street, West Hollywood, CA, 90069, US

(21) Appl. No.: 12/315,987

(22) Filed: Dec. 8, 2008

(51) Int. Cl. E21C 41/00; B07C 5/04; E21C 37/00; E04B 1/66

(52) U.S. Cl. 299/16; 209/644; 299/10; 427/136

(57) ABSTRACT

Coal burning waste gases, notably carbon dioxide (CO2), can be removed or sequestered, and the distribution and utilization of coal as a safe, efficient, and convenient heat source can be improved.

Carbon dioxide, a waste gas as from a coal burning process, can be sequestered within freshly fractured rock particles, such as Oligocene rock serpentine, using an adapted version of a rotary collider to fracture down hens-egg sized incoming rocks in a pressurized waste gas. The process sorts the small, fractured rocks and coats them after CO2 sequestration with a cementitious coating for use as a component of building material.

In order to improve the transport and delivery of mined coal it is an advantage to fracture the coal and coat the particles with an aqueous liquid. The methods and apparatus deal with the improved delivery of said liquid-coated coal particles for current and new customers who become interested in using coal as an economical heating fuel.

### CROSS REFERENCE TO RELATED APPLICATIONS

Applicant claims priority of the following provisional applications, for each of which he is the inventor:

a. Versatile System for Coal Purification, Coating, Transport, Storage, Recycling, and Distributed Use by Households and Small and Medium Sized Power Plants

### Filing Date: May 26, 2006

### Application #: U.S. 60/808,672

b. System for Efficient Sequestration of Carbon Dioxide

### Filing Date: Feb. 1, 2007

### Application #: U.S. 60/898,672

c. Fractured Oligocene Particles for Carbon Dioxide Waste Gas Sequestration System

### Filing Date: Apr. 23, 2007

### Application #: U.S. 60/925,668

### 1. BACKGROUND OF THE INVENTION

The US has large reserves of coal, both bituminous and anthracitic, but has very little petroleum reserves. There are some reserves of natural gas, but these are not large enough to supply the need to generate heat and electricity, or more particularly, not enough to supply vehicular fuel needs. Thus, the US imports vast quantities of petroleum from the Middle East, Canada, and Venezuela. This causes severe problems in fuel supply prices, and during the Spring of 2006, the price of light sweet crude rose to over $70 per barrel, causing some chaos on the stock markets.

In 1975 coal consumption was about 550 million tons/year, roughly the same as around 1920 and 1943. However, since the 1930s there has been a total transformation in the economic sectors which consume coal. Before 1945, coal consumption was divided among electric utilities, railroad, residential, and commercial heating, oven coke, and other industrial processes. The railroad demand was particularly high during the war years of the 1940s. Within one decade, coal consumption by railroads and by residential-commercial users essentially vanished. Currently, electric utilities constitute the main coal-consuming sector, and the trend of total coal use in the United States since 1960 has been determined by the coal demand of electric utilities.

There is an urgent need more efficiently to tap our coal reserves for heat and power. The mining of coal has been well developed, both for deep mining as well as surface mining (FIG. 1). However, there are problems with both types of mining—deep mining is still hazardous, and surface mining leaves large areas of the US in very poor condition after the mining ceases. There is substantial evidence that carbon dioxides emitted from coal burning are a significant contributor to global warming. There are also other waste gas problems with poorly controlled burning of coal, so that large quantities of nitrous oxides and sulfur dioxide are often emitted.

The proposed system provides a more efficient means of sequestering carbon dioxide, as well as preparing coal for transport, and thereby of utilizing it more efficiently for centralized and local generation of heat and power. Where practical, coal may be prepared for use at smaller power or heat generation sites to augment the current proclivity for “large plant” coal utilization. Although some off-the-shelf components may require further adaptation to smaller power plant sizes or heating systems, the proposed system shows the promise of supplying heat and power even to individual buildings and homes in a clean, safe, and efficient manner.

### Rock Crushing

Typically larger rocks are broken into smaller rocks in some type of mill. The rocks enter a chamber through an inlet portal in which objects are crushed, as by a crushing means within the chamber, often by raised areas on the chamber walls. These raised areas act to oppose other crushing means, so that the intermediate rock is crushed into smaller size pieces.

Coal, as a rock, is usually mined in large blocks or lumps, which are crushed down in size for transport, as by rail and ship to the coal burning site.

Coal, when burned, provides ample heat for various industrial or commercial purposes, but the burning of coal also releases substantial quantities of unwanted gases in the vent stacks, called flue gases. One of the waste gases, CO2, has been highlighted as causing “Global Warming” by trapping heat in the atmosphere—often called a “greenhouse gas”.

### Sequestration of CO2

Carbon dioxide is a “global warming” gas and is produced by several commercial processes, notably as a gaseous component in the flue gas emitted by coal burning furnaces. Present CO2 sequestration processes are cumbersome, and only the use of liquified CO2 as a refreshing material in existing oil wells is commercially justified. Liquifaction of CO2 into a pumpable liquid is expensive, and only when oil fields with “refreshable” wells are near to coal burning plants is the system cost-effective.

It is known that Oligocene minerals, such as serpentine, can sequester CO2 gas, although in nature the gas sequestration process can take decades or longer.

### Coal Processing Systems

Coal has been mined and transported for burning for heat production for several thousand years. As noted in the above background statement, in the last 50 years the use of coal has shifted toward coal burning at only large plants, usually to develop steam in boilers for conversion to electric power, or occasionally space heating. Direct turbine generation of power using coal and small site burning of coal has effectively stopped. Other fuels such as refined petroleum oil or natural gas from deep wells have effectively replaced coal as a fuel source.

### SUMMARY OF THE INVENTION

Described is a rock handling system that significantly speeds the process of sequestration of CO2 from waste gases, and as a byproduct, converts small, fractured serpentine particles into usable, building filler materials. A valuable, long term storage site for CO2 waste gas is provided, which also provides a commercially usable building material as a byproduct.

Further described are ways for improved transport, distribution, and utilization of coal as a heat source.

### Proposed CO2 Waste Gas Sequestration System

When freshly fractured, serpentine type Oligocene minerals expose many fiber-like layers. These fiber-like layers can adsorb the CO2 and are chemically converted to compounds such as magnesium carbonate and water, as one reaction example.

In order to speed up the sequestration process, a processing technique is employed. It is desirable to avoid physically crushing the serpentine, as this tends to seal the fiber-like layers together and cause a greasy-like exterior which does not readily adsorb CO2. FIG. 1 shows a schematic of the proposed processing system.

As mined, serpentine is taken from the ground in large lumps or blocks. For processing, it is desirable to convert the mined lumps or blocks into smaller units, which are about the size of hen's eggs. This can be done by standard ore crushing units, such as oscillatory crushers, since this crushing only has an impact on the bulk exterior of the relatively large serpentine rocks. Crushing will usually be done before rail or other transport of the serpentine rock to the sequestration site, usually near existing coal burning plants.

At the sequestration site the egg-sized lumps are fed through a gas gate into a device sometimes known as a “rotary collider.” The basic “rotary collider” was proposed and built by Deep Rock Drilling Company of Opeleika, Ala. about two and one-half decades ago. One version of a rotary collider is further described in U.S. Pat. No. 5,368,243 issued in 1994 to James J. Gold.

The basic form of a rotary collider is retained, that of a multi-lobe rotator revolving at very high speed within a cylindrical container. A “laboratory size” collider cylinder might be 2 feet in diameter with a casing of ten inches deep and an electric motor of about 40 horsepower, which furnishes the nearly transonic rotor face speed. The lobe faces are rotating at such a high speed (about 5,500 rpm for the laboratory model) that a transonic gas layer is formed at each lobe face. When the large rock sizes enter—here, approximately of hen's egg size—they are flung towards the periphery of the casing, but cannot normally touch the lobe faces because of the high pressure gas boundary layer on these rapidly rotating lobe faces.

Inter-collisions of the interior rock particles cause rapid fracturing of the entering serpentine rock. The reason for the provision of a gas lock on the entry portal of the collider is that it is desirable to fracture the serpentine rock in the presence of pressurized hot flue gas, and the gas lock allows the pressurization of the collider through a large axial fan which takes in flue gas from the nearby coal burning unit. The gas lock can take many forms, but a suitable form is to use a standpipe filled with water just below the input hopper. Since the weight of the water column balances against the pressurized interior flue gas in the collider, an effective seal for gases is formed, so that the hot flue gas will not emerge from the entry portal of the collider, but instead stay within it. Note that this hot flue gas may be pressurized above atmospheric pressure by, for instance, an axial fan, so as to increase the absorption of CO2 by the serpentine rock particles. It is desirable also that the particles reach at least 500 F during fracturing so as to increase the chemical bonding of CO2 within the fractured serpentine rock. The angled auger conveyor meters the entrance rate of the serpentine rocks into the entry portal of the rotary collider, and this entrance rate can be varied by speed adjustment of the drive motor for the auger.

The interior of the collider is filled with serpentine rock particles of various sizes, and the inter-collision of these particles rapidity reduces the particle size. It is favorable to remove smaller particles at the outer diameter of the collider cylinder, usually by a wedge shaped exit portal.

At this stage of rock processing, we want to sort the particles by size before allowing them to exit the collider. One efficient way to do this is by the use of a row of small high pressure gas jets (hot flue gas) forming a picket fence of small diameter jets. By spacing these jets across the entrance to the wedge shaped exit zone of the collider, the “sorting” picket fence is formed. Particles that are desirably small enough (breakfast rice crispie size) can pass between the high pressure jet “fence bars”, but larger particles are deflected back down into the interior of the collider by the force of the gas jets. Since the exit wedge will have to have a relatively sharp front edge, it may be desirable to provide a high pressure “air knife” (here, flue gas) that prevents the rapidly moving particles from hitting the sharp edge of the exit portal (so as to prevent smearing over the surface of the fractured rock so that the gas absorption rate would be reduced).

Particles deflected back into the collider will, of course, continue in their inter-collision mode with other serpentine particles until they are small enough to be passed through the picket fence of gas jets. It is likely that the picket fence spacing and jet diameters will have to be adjusted by using high speed strobe Schlieren or Shadowgraph observation through a quartz window, which will replace a section of the collider casing just above the gas jet picket fence. Even a quartz view plate in the region of the gas jets may be eventually scoured by sliding collisions with the flying serpentine particles, but should be viable for sufficient observations, so as to adjust optimally the physical parameters of the picket fence jet nozzle array.

In the wedge-shaped exit of the collider, the particles are flying out at high speed towards a large circular vortex collector bin. A second rotary collider facing in the opposite direction also has its exit wedge portal facing the same vortex collector bin. Many particles traveling in opposite directions (and slightly downward) from both exits will collide. A fan above the inter-collision zone of the two exit wedges is utilized to create a rapidly rotating cyclone of flue gas. It is expected that the inter-colliding serpentine particles will tangentially interact with the vortex bin walls and lose velocity as they change from their trajectory paths to new circular paths at the periphery of the cyclone vortex. In their shape the cyclone vortex bin looks like the sawdust collector which is used at most sawmills to gather and sort sawdust for disposal.

At the sump zone at bottom of the cyclone vortex the rock particles are gathered into the entrance feed of a rotating spiral auger transport. This spiral auger transport gathers and transports the collection of serpentine particles at an angle, for instance, 35 degrees above horizontal.

After about foot of angled travel the collected rock particles pass over a long, bar shaped ultrasonic transducer. The auger vanes in this region are somewhat flexible and deflect over the ultrasonic transducer bar. This deflection of the flexible auger blades forces the passing rock particles into close contact with the ultrasonic bar. The bar imparts energy into the particle-gas mix, and the cavitation so produced increases the transport of waste gas into the interior of the passing rock particles.

After a few feet of upward travel, the transport auger is vented at the top of the auger through hoses to a watery pool. Any pressurized flue gas remaining within the serpentine particles is transported upwards through the hoses. The escaping gas pressure results in a swirling, bubbling pool of liquid at the liquid-gas interface in the liquid bath. The ultrasonic transducers at the end of the gas ducts encourage the formation of carbonic acid as the CO2 gas interacts with the water bath.

To encourage any residual gases to leave the auger transport, the top of the spiral auger casing is equipped with a plurality of rubber gas vent slits in a line along the spiral auger transport tube roof. When the gas pressure in the transport casing is greater than the column of water outside, the gas will exit into the liquid pool. The flexible lips of the vents will reduce the amount of serpentine “fines” that might escape with the exiting gas.

The depth of the water above the exit of the hoses forms a pressure “seal,” so that only gases of that pressure or more can exit from the hose. The diagram shows two hoses. The leftmost hose contains a poppet valve which only allows gases of somewhat higher pressure to exit, about one-half to one atmosphere. The rightmost hose has no poppet valve and will allow any gases at any pressure to escape.

The water pool would be maintained at a slightly basic pH, as by addition of an inexpensive material such as soda ash, so that the CO2 in the escaping gas bubbles will combine in the watery pool to form a neutralized precipitate with the carbonic acid (formed by the CO2 chemically combining with the water of the pool's liquid). This precipitate and any “escaping” serpentine fines will be regularly extracted from the watery liquid pool. It is intended that this pool water will be used to form the cementitious coating of the fractured serpentine rock now that they have reached “rice crispie” size.

This pool water can also contain surfactant, so that the watery liquid will fully coat the serpentine particles when the mix of pool water and dry cement coat materials is added to the spiral auger near the upper end. When the wetted particles are transported up to the exit of the transport spiral, they will emerge into ordinary atmosphere. The exiting coated particles can be “de-wetted” if necessary, as by high speed centrifuge. The thin, watery cementitious coating has been already applied to the wetted serpentine slurry. A protein is present in the cementitious coating to aid in spincule formation in the encasing cement, and if necessary, a fast-drying accelerant is added. The mix, now almost dry, is further transported to a dryer unit whose encasing jacket is heated by exchange with flue gas coming into the collider portion, so that the coated particles are heated to “dry” the cement coating. Preferably, these coated serpentine particles would be conveyed to a Johnson type rotary dryer (a large cylindrical drum in the shape of an elongated rotary clothes dryer is often used to dry breakfast cereals in large volume), so that the coating will completely dry. As a result the dried, coated particles are now ready for use as a construction material “filler” and can be stored in bulk, awaiting delivery to a manufacturing plant or construction site.

The figure of merit for this CO2 sequestration process is “volume of serpentine needed to capture the majority of CO2 in the flue gas per volume of coal burned in the adjacent coal burning furnace. Present industry tests indicate that with normal “serpentine bed” capture of the CO2 during coal firing, it takes eight tons of serpentine to capture most of the CO2 when firing one ton of coal. Consequently we may examine the process efficiency of capture by examining this ratio after use of the collider and its associated equipment. We can again measure the ratio of volume of serpentine rock/volume coal burned and compare this result with the normal 8/1 ratio.

Under the proposed approach the usual “bag house” collection of rock fines at the exit of a rotary collider is eliminated and no “fines dust” is emitted from this sequestration process. Rather, the CO2 embedded in serpentine is collected and coated with a sealant (a variation of portland cement), so as later to be used as an economical building material or constituent. The coated particles can be an immediate commercial substitute for fly ash or other expanded perlite products. The higher weight per volume of the coated serpentine particles will be especially suitable for fabrication of sound reducing wall panels.

### The Proposed Coal Transport and Utilization System

The mining of coal has been well developed, both for deep mining as well as surface mining. There are problems with both types of mining. Deep mining is still hazardous and surface mining leaves large areas of the US in very poor condition after the mining operations cease. There are also problems with poorly controlled burning of coal, so that large quantities of nitrous oxides and sulfur dioxide are often emitted, in addition to the concern that CO2 emitted from coal burning is an important contributor to global warming.

Assuming that coal is brought to a railhead for transport, it is usually crushed by, for instance, an oscillatory crusher, so that the resulting coal lumps are usually less than a 4″ cube in size. While this size lump is readily loaded aboard open top hopper cars, the volumetric packing is only fair, so that often trains of 100 hopper cars are required, often hauling more than 10,000 tons per train.

It is here proposed that after oscillatory crushing to about 4″ cubes, the coal is then powdered by a version of a “rotary collider” mill of the type, which has been described earlier. Correct design and location of the exit ports on the rotary collider can ensure that all incoming coal is powdered down to a small size (usually below 0.005″ in size). Any larger sized pieces will usually be much harder material, such as scrap iron that has found its way into the delivered coal, and these can be separately ejected or collected on a tramp iron magnet surface.

Because the powdered coal can readily burn, and even become explosive when the powdered coal is ejected in an air blast, it is proposed here that the powdered coal be immediately mixed with a solution of water and ammonia, usually about 26% ammonia by volume. The mixing can be by spray admixture at the powdered coal exit ports of the rotary collider. To get efficient mixing of coal dust and liquid, it is favorable to compress the liquid mixture to over 2,000 psi (as by industrial versions of a car wash pump), and pass it through needle nozzles (as from Mee Industries, Pasadena, Calif.). The high pressure water-ammonia mix, when impinging on an upturned needle point, causes the mixture to create true fog, ie, below 1 or 2 micron fog partible size. It is also useful to add a very small amount of non-sodium surfactant, such as Lauryldimethylamine-oxide (LDAO), to the water-ammonia mix to lower markedly the surface tension of the fogged liquid, so that mixing with the developed coal dust is efficient and rapid. The volume added of Lauryldimethylamine-oxide is at the 0.01 mole level, or less. Although Lauryldimethylamine-oxide is a commercial surfactant, it is possible to use almost any saponifier as a surface tension reduction agent, so long as it does not have sodium or potassium in its composition, which can “plug” certain catalytic converters used in waste gas handling after burning of the coal.

The mixing with the aqueous liquid renders the coated coal dust very safe to transport, and the surfactant makes it easy to pump the coal-liquid mixture into standard petroleum transport rail cars or shipboard tanks. Since these have only minor vents to air, there will be little evaporation of the liquid during transport, and the mixture will only freeze at very low temperatures, not likely to be encountered in most parts of the US. Even with the weight of the added ammonia-surfactant liquid the powdered coal is now volumetrically in a very efficient state for transport, so that less transport rail cars will be needed to bring the coal to the point of use or further transport.

Although the rotary collider, which has been designed to handle 4″ input lumps of coal, is quite large and heavy, it may still be transported by flat bed rail car or highway “low boy” trailer to make it available to the desired location for lump to powder conversion. The rotary collider electric motor will usually operate on 3 phase 440 volt electricity for economy, but can be equipped to work on 220 (2 or 3) phase, or even be powered by a truck size diesel engine where electrical power is not readily available.

The coal-liquid mixture is readily pumped, especially when a surfactant has been added. If the change in height between pump point and discharge point is not too great, centrifugal pumps may be used. When the height is greater, it is more favorable to use piston-stroke pumps. This will enable the rotary collider to be located away from the exact railhead point and will allow for more delivery options at the final delivery location. On occasion powdered coal has been stored in “heaps”, as at a shipping receiving station near a power plant, and the wind has a tendency to blow the “super fines” of the heap toward the neighbors, making this method of storage unpopular. When heaping piles are exposed to the weather, rain runoffs can meander towards neighbors' properties, which will further aggravate the storage problem. The delivered coal-liquid mixture can be readily stored in standard petroleum tanks, or alternately, within “cement ring” structures. Using the proposed coal-aqueous liquid mixture enables the tank contents to be almost non-flammable in bulk storage. The fine grain of the coal that forms the particle lattice in the mixture means that the mixture will exert somewhat less force on the tank walls than would liquid crude petroleum on a similar volume basis.

This method of tank storage can be used at the coal mine site, if desired, so that between train car arrivals, the liquid-coal mixture can be made up and stored. Ideally, when a storage tank is used, there would be a multiplicity of pumps used so that, for example, five or more cars could be filled at once from the storage tank, reducing the number of times the shunt engine has to move the train to bring empty cars to the filling point. Although it would require a small bit of development, the standard coal hopper cars can be used to transport the coal-liquid mixture. It would be favorable to have made up hopper lid structures that have convenient “grabber bars” atop the lids so that the lids can be readily removed for hopper car filling, as by gravity filling from a storage tank well above the filling level, after which filling the lids are replaced. The weight of the lid plus slightly wedged sides allows the lids to fit any standard hopper car, so that removal of lids and stacking them near the filling point is entirely practical. The lids only have to fit so tightly that the liquid-coal fill will not “slop out” should the train handling cause somewhat violent starts or stops.

Whether the coal-liquid mixture arrives by train car, ship or overland pipes, we can assume that it will be placed in large storage tanks for holding before use. For nearby power stations or heat generation plants, the coal-liquid mixture can be readily piped, much as can be done with currently used large diameter “coal dust” pipes which connect sea port shore delivery stations to coal-burning plants.

The use of an ammonia-water-surfactant-powdered coal mixture as a fuel allows the coal burning plant operator to use one of two options: (1) Burn the liquid-coal mixture (direct burning) or (2) Remove most of the liquid from the coal before burning (indirect burning) The direct burning (option 1) of the ammonia-water-surfactant-powdered mixture in the coal burning furnace will release significant amounts of ammonia as a furnace byproduct, and in some bag house post treatment systems, this amount of ammonia is enough to complex out the NOx components and “clump them” so that post-burning bag walls can capture the complexed reaction particles for later removal. Of course, the furnace operator can elect to add more water-ammonia mix to the effluent flue gases before the bag house, but usually, it would be more favorable to extract the water-ammonia-surfactant liquid from the incoming liquid-coal mixture, so that little or no additional water-ammonia liquid needs to be added.

In Option 2, the ammonia-water-surfactant portion is largely removed by centrifugal spinning, or by stroke pumping the mixture over a fine sieve plate. When the coal dust is largely separated from the liquid mixture, it can be burned by introducing it directly into standard boilers. The ammonia-water-surfactant extraction is then added AFTER burning, as at the entrance to a bag house to a post-burning anti-NOx catalytic reactor using a rare-earth zeolite catalyst. If the zeolite manufacturer is notified about the use of Lauryldimethylamine-oxide, experiments can be conducted to assure that the chosen surfactant will not “plug” the catalyst, even after long use. One prominent NOx removal zeolite manufacturer is Siemens (Munich, Germany).

The ammonia-water-surfactant liquid coating of the powdered coal offers other delivery options to small scale customers when compared to large coal burning plants. The liquid plus coal mixture can be pumped by delivery trucks directly to holding tanks in a house or small business for direct feed to a flame boiler for water or house air heating.

Additionally, smaller amounts of the liquid-coal mixture can be packaged in a burnable jacket, such as heavy cellophane for “package storage” as input stock for a furnace. People who have installed wood pellet burning stoves or furnaces and experience difficulty in getting the wood fuel pellets could easily use the coal-liquid package as a fuel source. It would even be possible to offer a product line of fireplace “logs” using a similar package, but one with minerals added that lend color to the flame while burning. The vaporized ammonia released during such “log” burning could also help clean the chimney.

### BRIEF DESCRIPTION OF THE DRAWINGS

FIG. 1 is a side view schematic of a preferred embodiment of the entire rock processing apparatus, entitled “System for Processing Oligocene Rock Lumps”. Two rotary colliders are provided, the leftmost with ejecta exit facing right, the rightmost collider with ejecta exit facing left.

FIG. 2 is a side view schematic of the gas seal apparatus, entitled “Gas Pressure Seal System, allowing input of Oligocene rocks to rotary collider with internal flue gas pressure”.

FIG. 3 is a side view schematic of the leftmost rotary collider, entitled “Modified Rotary Collider” (permitting fracturing of input rock in presence of pressurized flue gas).

FIG. 4A is a side view schematic of the particle deceleration equipment and the ultrasonic equipment, entitled “Vortex Particle Decelator and Ultrasonic Energy Plate,” and FIG. 4B is entitled, “Detailed View of Auger Blades Deflecting When Passing Over Ultrasonic Energy Plate.”

FIG. 5 is a side view schematic of the system for venting any remaining gas pressure (after the ultrasonic plate region), and of the cementitious coating equipment, entitled “gas relief system and coating mixer/applicator”.

FIG. 6 is a side view schematic of a preferred means of drying the coated rock particles, entitled “Coated Particle Drying System”

FIG. 7 is a schematic of Coal Mining Operations

FIG. 8 is a schematic of Raw Coal processing in preparation for long distance transport

FIG. 9 is a structural diagram of “LDAO”—Lauryldimethyamine Oxide, a surfactant chemical

FIG. 10 is a schematic of Coal Slurry Delivery

FIG. 11 is a cutaway pictorial of a Solar Model T130 “Titan” Gas Turbine

FIG. 12 is a view of a Solar 130 Gas Turbine modified to provide an integral fluidized bed

FIG. 13 is a side schematic view of a Gas Turbine with integral fluidized bed shown cutaway

### DETAILED DESCRIPTION OF THE PREFERRED EMBODIMENT

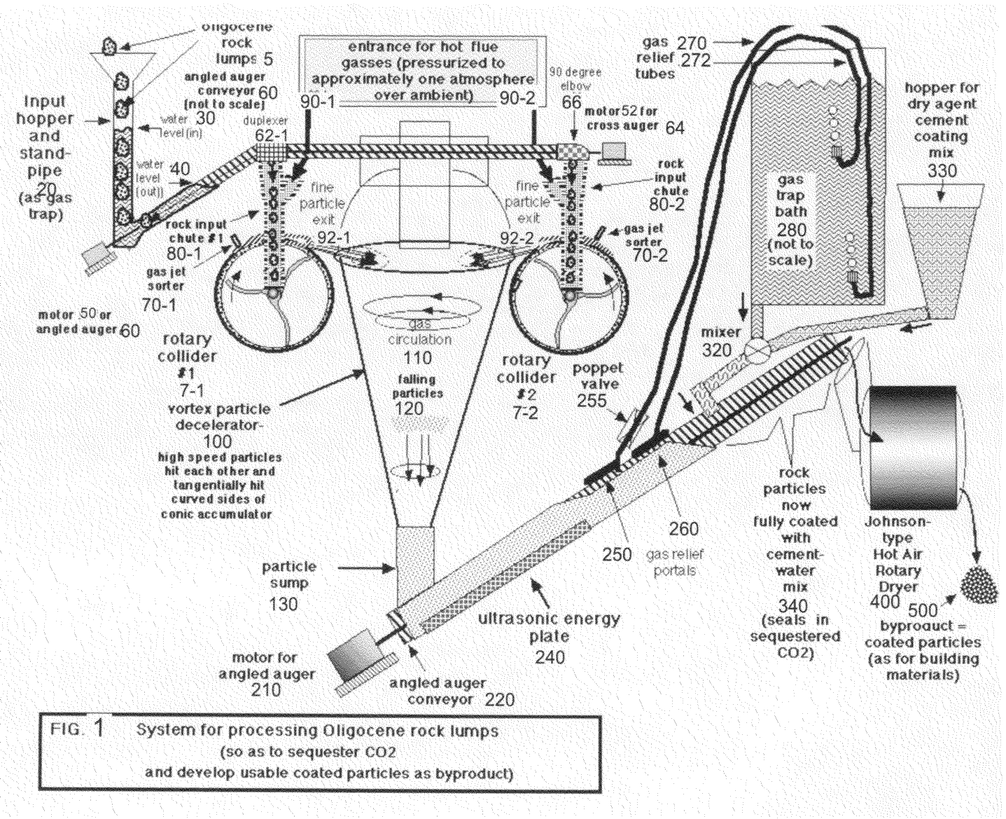

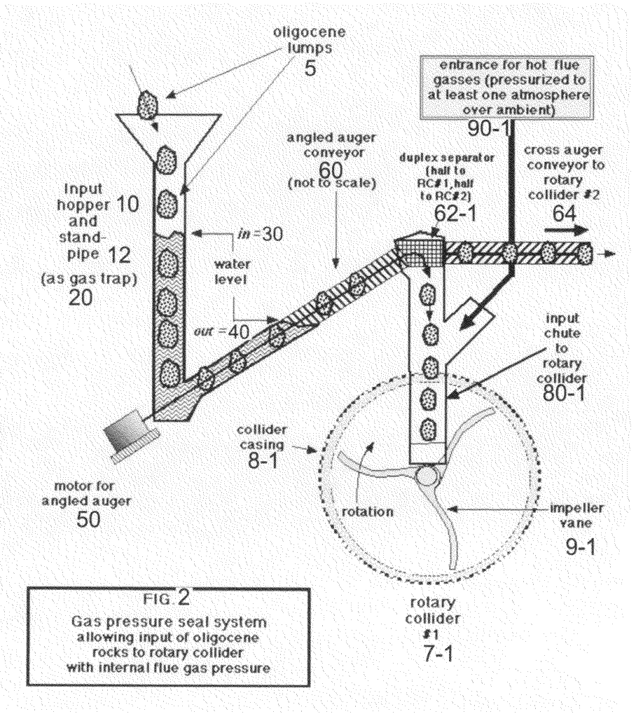

Viewing FIG. 1, the Oligocene rock lump input station 20 is at upper left. and consists of a input hopper and standpipe, to be described in more detail when viewing FIG. 2. The standpipe in 20 is filled with water, whose weight will counterbalance the force of flue gas, as 90-1 which has pressurized both the leftmost rotary collider 7-1 and the rightmost rotary collider 7-2.

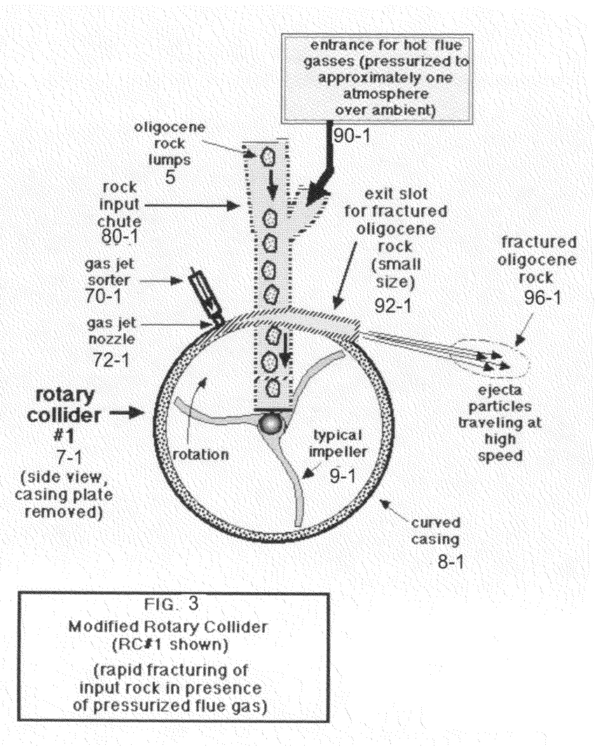

The rightmost rotary collider 7-1 has its ejecta exit (fine particle exit 92-1) facing rightward, and the leftmost rotary collider 70-2 has its ejecta exit (fine particle exit 92-1) facing left, both ejecting particles into the vortex particle decelerator 100 to be further described when viewing FIG. 3.

The remainder of the equipment in the rightmost portion of the schematic of FIG. 1 is utilized to subject the gathered fine particles in the vortex sump 130 to ultrasonic energy from ultrasonic energy plate 240, and to vent any remaining gasses to a gas trap bath 280, before coating the particles with a cementitious mix 320 and then drying them 400, so as to form a useful byproduct 500, as for use in the building trades.

In FIG. 2, the Oligocene rock lumps 5 enter the input hopper 10 and standpipe 12 which with angled auger conveyor 60 comprise the input gas trap 20. The standpipe 12 is filled with water, and because the rotary collider (left most collider 7-1, for example) is filled with pressurized flue gas 90-1, the flow of flue gas downward along angled auger conveyor 60 will cause its level to be displaced downwards, as water level 40 (“out”). In contrast, the flue gas pressure will displace the water level in the standpipe 12 to rise, as shown by inlet water level 30.

The rock lumps are escalated up the angled auger convey 60 to a duplexer separator 62, which divides the rock lump flow into two parts, one half to comprise the rock lump feed down input chute to the rotary collider 80-1, the other half to be passed by the horizontal cross auger conveyor to the rightmost rotary collider (7-2, not shown in FIG. 2.

A cutaway side view of the casing 8-1 for the leftmost rotary collider 7-1 is shown, along with a side view of the interior impeller vane 9-1.

In FIG. 3, a side view schematic of the leftmost rotary collider 7-1 is shown. The pressurizing flue gas 90-1 enters the rock input chute 80-1, which is also receiving Oligocene rock lumps 5. These rocks 5 fall under gravity and are deflected into the interior of the modified rotary collider 7-1. As stated before, in the laboratory model described, an input “time window” when a rock lump 5 may enter the interior cavity of the rotary collider 7-1 will present itself about every 11 milliseconds.

Once inside the rotary collider 7-1, the rock lump 5 will hit other rocks that have previously entered, and will be impelled to rotate by one of the faces of the impeller 9-1 (three impeller blades 9-1 are shown). The impeller blades 9-1 are rotating a such a speed that a transonic pressure wave is built up before the blade 9-1, preventing the rock lump 5, or a fragment thereof, from actually touching the blade 9-1 face. Thus, the major rock fracturing method within the rotary collider is by inter-collision with other rock particles, thus reducing wear on the rotary collider 7-1 itself.

It is desirable to remove the fractured particles 96-1 from the interior of the rotary collider 7-1 when they have become small enough, as an example, when they reach “rice crispie” size. To do this a gas jet sorter 70-1 with a gas jet nozzle 72-1 are installed. Pressurized flue gas emits from the nozzle 72-1, and the gas jets are arranged across the width of the rotary collider 7-1 (here, about 10 inches in the laboratory model). This array of gas nozzle jets 72-1 forms a “picket fence” across the depth of the rotary collider 7-1 just before the particles will pass by exit slot 92-1. If the particles 96-1 are small enough to pass through the “picket fence” row of gas nozzle jets 72, centrifugal force will encourage them to exit through the exit slot 92-1.

If the rock lump 5 fragments do not pass through the “picket fence” of gas nozzle jets 72-1, they will be deflected downwards back into the main cavity of the rotary collider 7-1, wherein they will be further subjected to inter-collision until they are of sufficiently small size to pass out of the rotary collider at exit slot 92-1. As mentioned previously, it may be advantageous to use Schlieren or Shadowgraph imaging to adjust preferentially the row of gas nozzle jets 72-1, as through a quartz plate (not shown) mounted in the casing 8-1 of rotary collider 7-1 near the gas nozzle jets 72-1.

The ejecta particles of fractured Oligocene rock 96-1 emitting from rotary collider 7-1 at exit slot 92-1 will have a very high rightward speed, and the exit slot 92-1 is positioned so that the ejecta particles 96-1 will have a mild downward angle, perhaps 20 degrees to the horizontal.

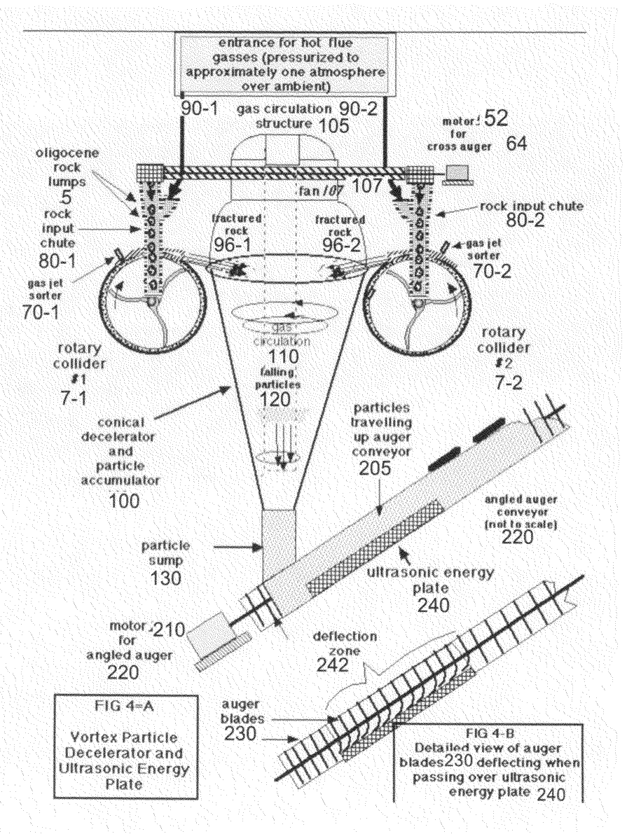

FIG. 4A shows the Vortex Particle Decelerator 100 and its adjacent ultrasonic energy plate 240, and the inset FIG. 4B shows an interior view of the auger blades 230 deflecting when passing over the ultrasonic energy plate 240.

In FIG. 4A, both the leftmost rotary collider 7-1 and the rightmost rotary collider 7-2 are shown. The leftmost collider 7-1 ejects its fractured rock 96-1 rightward (and slightly downward) into the conical particle accumulator 100, whereas the rightmost rotary collider 7-2 ejects its fractured rock 96-2 leftward into the accumulator 100. It is expected that this will result in further rock particle inter-collisions, but will also give a net speed deceleration particles 96-1 and 96-2 as they whirl around in the conical accumulator 100. A fan 107 produces a strong downward and circular current of flue gas with the accumulator 100, so as the particles 96-1 and 96-2 whirl around the interior of accumulator 100, there is a net downward drift motion vector and marked speed deceleration of falling particles 120 downward into particle sump 130 at the bottom of accumulator 100. A side vent 105 above the particle sump 130 allows the interior gas to be returned to the gas circulation structure 105 at the top of accumulator 100, and thence to fan 107 for its downward passage onto the fractured rock particles 96-1 and 96-2 flying into accumulator 100 from the “next batch” of rock 5 fracturing by rotary colliders 7-1 and 7-2.

After the falling particles 120 have settled in the particle sump 130, they will be carried upward at an angle by the auger conveyor 220, powered by the auger motor 220. The spiral auger blades 230 (see FIG. 4B) rotate, so as to angularly move the collected particles 130 up and to the right. An ultrasonic energy plate 240 has been installed in the bottom of the auger tube 220. The ultrasonic energy plate 240 extends up into the path of the auger blades 230. The auger blades are constructed of flexible material in deflection zone 242, and they deflect as shown in FIG. 4B. This deflection in zone 242 puts heavy pressure on the particle and gas mixture under the blades in this region 242, so that much of the vibratory energy imparted by the movement of the ultrasonic energy plate 240 will pass into the gas-particle mixture. This ultrasonic energy will cause severe cavitation of the mix, and serve to force the flue gas into the interior of the fractured particles, where either physical sequestration or chemical reaction sequestration will serve to fix the flue gas (90-1, 90-2) within the fractured rock 96-1,96-2). The gas-particle mix continues to travel up the auger conveyer tube 220, impelled by the spiral blades 230 past the ultrasonic energy plate 240.

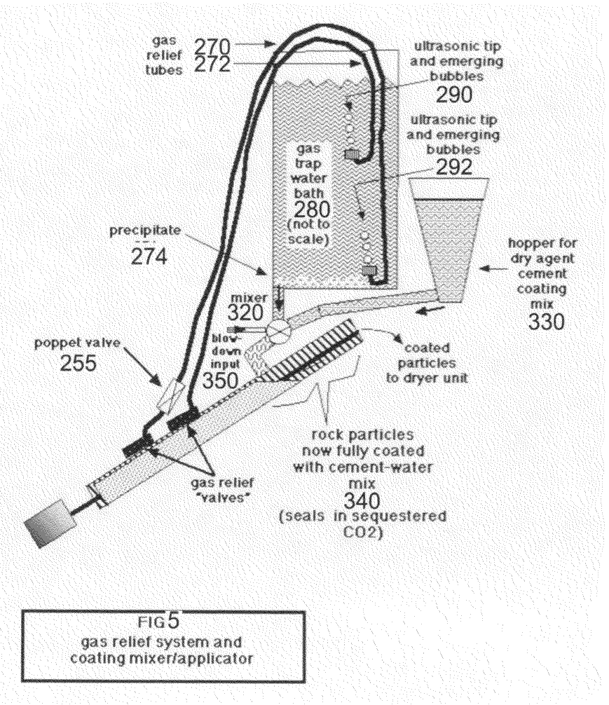

In FIG. 5, the upward passing rock-gas mix moves into a region of the conveyer tube 220 whereon gas relief valves 250 and 260 are mounted on the top surface of the conveyor tube 220. These gas relief valves (250,260) are in the form of elastomeric hoses with slits in their lower side. The slits are formed into lips 252, 254 which face upward so as to readily admit flue gas, but attempting to exclude any fine rock particles.

Any flue gas that passes through the slit lips 252,254 will pass upward through gas relief tubes 270, 272. In gas relief tube 270, a poppet valve 255 is installed. This poppet valve is set to open when the gas pressure within rises above, say, ½ atmosphere and will close again when the gas pressure drops below that amount. The other gas relief tube 272 has no valve and will allow any gas passing through the slit lips 254 to travel in the tube 272. Both relief tubes pass into the gas trap water bath 280. Flue gas traveling in gas relief tube 270 will be at higher pressure than in gas relief tube 272, so gas relief tube opens to the water bath 280 at a much greater depth, so that the column of water above the exit has sufficient weight. Correspondingly, the exit of gas relief tube 272, having a lower interior gas pressure, can exit at a much higher level in the water bath 280. Note that both gas relief tubes 270,272 have ultrasonic tips 290, 292 which tend to cavitate the gas-water mixture in the tip region, so as to encourage the formation of carbonic acid (CO2 plus water). An alkalai soda (as soda ash) has been added to the water bath so that the carbonic acid formed will tend to form a neutralized precipitate 274 at the bottom of the water bath 280. As mentioned previously, a surfactant (such as Sodium Laurel Sulfate) has been added to the water to increase its future ability to coat particles.

A mixture of water from water bath 280 and precipitate 274 can emerge from the bottom of the water bath tank 280 into mixer 320. A hopper 330 containing a dry mix of coating agent, such as cement, and a mild protein (as milk protein) conveys the mix to the mixer 320. The mixer blends the liquid and dry mix and conveys the blend to the auger conveyor where it is poured onto the passing rock particles. The action of the rotating spiral conveyor blades 230 churns the liquid and dry mixture with the particles, so as to thoroughly coat them 340 before they reach the end of the spiral auger blades 230 in the auger conveyor tube 220.

A blow-down pressurized gas input 350 is provided to mixer 220, so as to clean out the mix line from the mixer downward when the equipment is shut down. This will serve to clear the mix line from mixer 320 into the auger blade 220 during periods of non-operation.

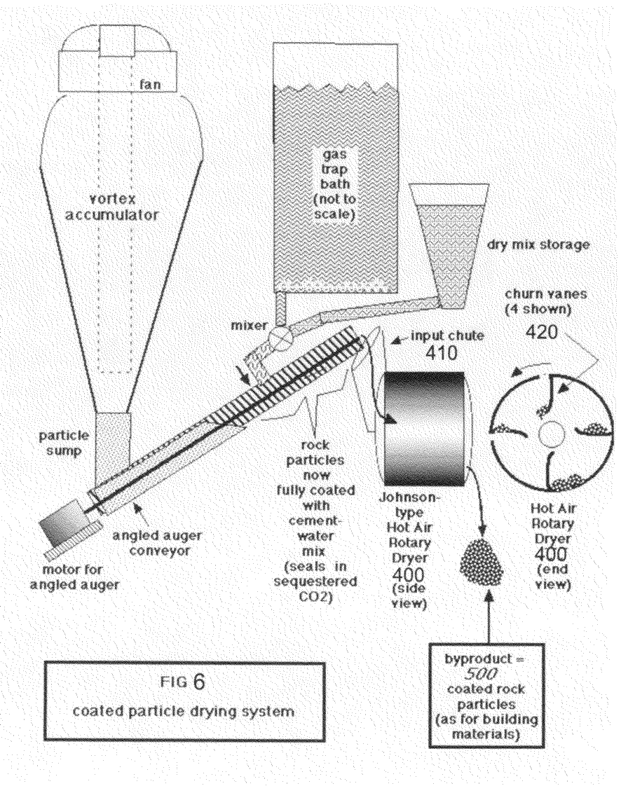

FIG. 6 shows the fully coated rock particles 340 emerging from the end of angled auger convey 220, whereupon they fall (by gravity) into the upper end of input chute 410 mounted on the leftward side of Hot Air rotary dryer 400. This dryer is similar to the Johnson Dryers commonly used to dry damp breakfast cereals during manufacture. An end view shows a cutaway view of the interior of the hot air dryer 400. Here, four vanes 420 are shown, which allow the damp coated particles to toss around in the hot air, drying them thoroughly. When completely dry, the particles emerge from the right side of the dryer, and have become a worthwhile byproduct 500 of this rock handling process. While somewhat heavier than the equivalent size fly ash particles (as byproducts of iron making slag), the coated Oligocene rock can readily be used for sound deadening wall board, filler for block making, or even for direct pour of floors. It is yet light enough to be used as a spray coating to provide fire protection for steelwork.

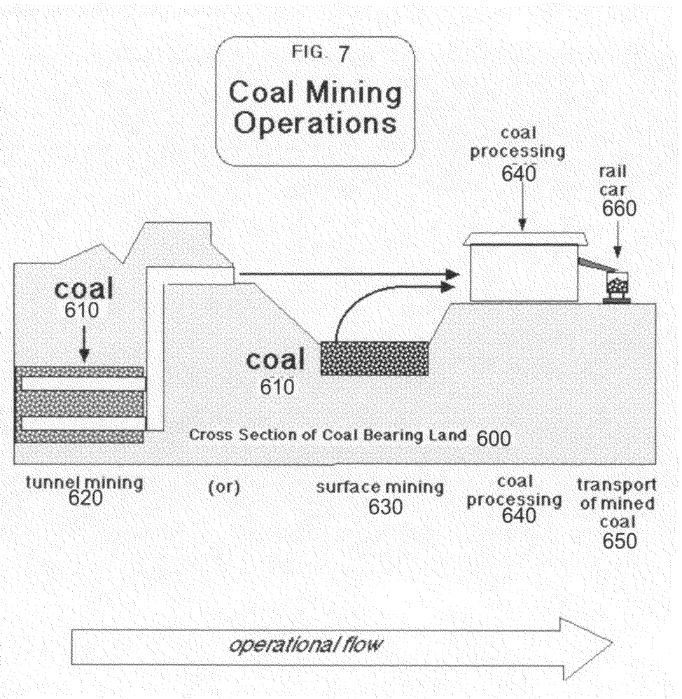

FIG. 7 is a schematic of coal mining operations taking place within Coal Bearing Land 600. (shown in cross-section). When coal is found at very deep regions, tunnel mining 620 is necessary. Long tunnels and shafts are necessary to reach high quality coal veins (only shown schematically). When the coal is closer to the surface, then surface mining 630 can be used to excavate the coat for further processing 840. After coal processing 840, the coal may be loaded for transport, as by rail car 660.

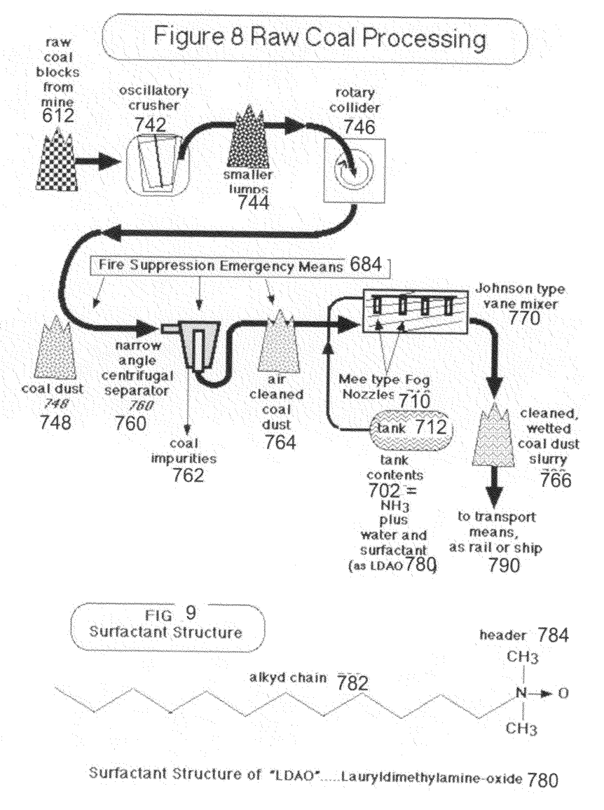

FIG. 8 is a schematic of raw coal processing 840. Raw coal block 612 can be taken from the deep mining 620 or the surface mining 630 operations. Many of the raw coal pieces are very large, and must be broken up for further processing, as by an oscillatory crusher 742. This crusher operates forcing the larger pieces between opposing walls so that smaller lumps 744 are obtained. It is recommended that these smaller lumps 744 are broken down still further into very fine particles, as by rotary collider 746. The rotary collider 744 used here is very similar in action to the rotary collider 7-1 shown in FIG. 3, and discussed above. The exit of the rotary collider 744 may be adjusted so that the emerging material is a coal dust 748, of an approximate size of 0.005 inches on the average. Note that coal when in a fine dust form, as is coal dust 748 is potentially explosive and a fire hazard. Thus, a Fires Suppression Emergency Means 684 is provided. First, such means 684 may provide a low oxygen atmosphere for the rotary collider 744, and the same type of atmosphere during transport, as to narrow angle centrifugal separator 760. The narrow angle centrifugal separator 760 is designed to remove inert materials, such as clay or inorganic sulfur from the coal dust 748. These coal impurities 762 exit the separator 760 as shown. Usually, an blast of compressed gas is used to accelerate the cleaning of the coal (not shown), producing air cleaned coal dust 764. To minimize the potential hazard of handling “dust fine” coal, the cleaned coal 764 is introduced into the entry portal of a Johnson type vane mixer 770. Within the mixer 770, an array of Mee-type fog nozzles 710 are placed in a row along the central axis of the mixer 770. When aqueous liquid, as from tank 712 is pressurized to about 2,000 psi, it will emerge from the tiny orifice of the Mee nozzles 710 and impinge on an upraised needle point (not shown). This produces a true fog of the liquid, with fog particles about 1-2 microns in size (these fog nozzles are sold by Mee Corporation which is located in Pasadena, Calif.). If the tank 712 is filled with mix 702 of ammonia, water and surfactant (as LDAO . . . see FIG. 9), the fog will preferentially coat the complete exterior of the coal dust. The ammonia (NH3) is added so as to represent about 26% of the total liquid volume. Only a tiny amount of the surfactant (as LDAO) is used, perhaps to the 0.05 mole level. The resulting clean, wetted coal dust slurry 766 is now prepared for long distant transport 790, as by rail or ship to the chosen site for utilization.

Viewing FIG. 9, the schematic structure of the surfactant “LDAO” 780 is shown. Lauryidimethylamine-oxide has as its “left tail” a series of alkyds 782, with the “right head” 784 centered on Nitrogen and exteriorly linked to Oxygen, with two methyl CH3's flanking the Nitrogen center of the “head”.

Most surfactants have this “head and tail” structure, as with the “head” being hydrophilic and the “tail” being hydrophobic in LDAO. This surfactant can also be written as CH3(CH2)11N(O)(CH3)2. Note that there are neither sodium or potassium in this surfactant. Since the surfactant will travel with the coal dust to the site for burning, it is important to use a non-sodium and non-potassium material in preparing the coal for transport. Many coal burning sites use SCR-type catalysts to complex out NOx in the exhaust flue gas after burning. These selective catalysts often use zeolite “sponges” which include rare earth particles to clump the NOx in the presence of ammonia. Even a little sodium or potassium in the flue gasses will eventually “plug” the catalytic zeolite, and would force its entire replacement (very expensive) and necessitating a long repair cycle.

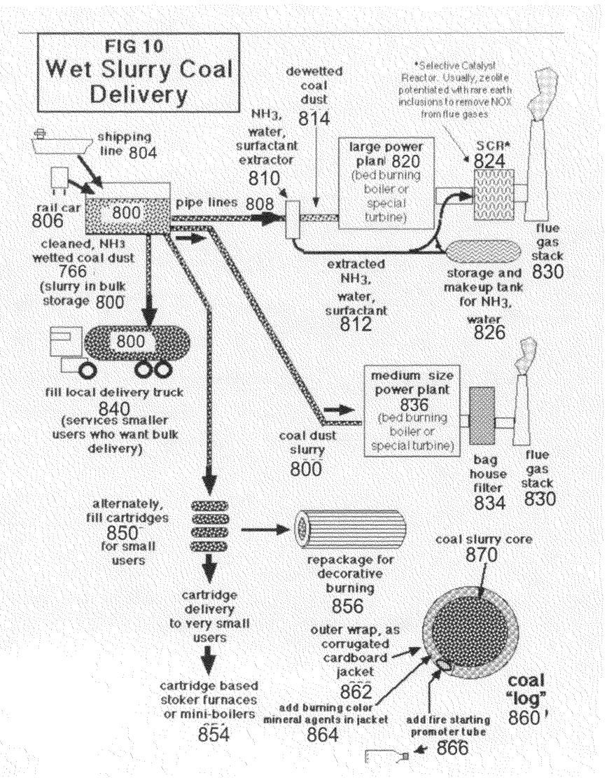

FIG. 10 is a schematic view of how the wet coal slurry can be utilized once it is close to its burning or utilization site. The cleaned, water+NH3 wetted coal 766 is brought to a bulk storage site 800 usually by ship 804, or by rail car 806. The wetted coal 766 is sufficiently fluid that it can be pumped in pipe lines 808 to its various points of use.

As example, the pipe line 808 may bring it to a large power plant 820 (upper right in FIG. 10). A large power plant will usually have a SCR (selective catalyst reactor) in place to remove NOx from the flue gas. In this case it may be favorable to “de-wet” the coal, as by a NH3 and water extractor 810, such as a rotary centrifugal separator. The “de-wetted” coal 814 is then fed directly into the burner of the power plant's 820 boiler or to a special turbine, if used. The extracted liquid 812 is largely NH3 and water. This liquid 812 can be placed into a storage and makeup tank 826. When the power plant is started, the NH3 and water solution is withdrawn from the tank 826 and introduced into the face of the SCR NOx remover 824, so as to clean it of NOx gases before they can leave into the atmosphere through flue gas stack 830.

At middle right, the pipe line 808 may alternately bring the wetted coal slurry 766 is withdrawn from bulk storage for coal slurry 800 and introduced directly into the medium size (or small) power plant 835. This plant will also use a bed burning boiler or a special turbine to convert the coal into heat. Here, however, the ammonia NH3 has remained wetting the coal, so that the NH3 will be released during burning. The NH3 will clump with the NOx gases during the burning, and may be extracted using the walls of a “bag house” filter 834. The burlap type walls of the bag house 834 will filter the exiting flue gases, and the cleaned flue gas will then be allowed to escape into the atmosphere using flue gas stack 830. Note that a bag house 834 is practical for a medium or small size power plant because the small flow of exiting gases allows a reasonable size for the bag house 834. These filters are called “bag houses” since they are at least the size of a garage, and for larger plants, the size of a small house. For a large power plant, the use of a bag house as a clumped NOx filter is a bit impractical, as it would take multiple “bag houses” to filter the much larger exiting gas flows.

At middle left, a pipe line 808 has brought the wetted coal slurry 766 from bulk storage 800 to fill local delivery trucks 840. These trucks 840 closely resemble the trucks that deliver bulk propane to customers. Here these trucks 840 would carry the wetted coal slurry 766 to smaller users who wish to store their coal supply on site, much as was done when “coal bins” were often found in households and apartment buildings. Since the wetted coal slurry 766 may be readily pumped to the onsite storage location from the delivery truck 840, this delivery system is convenient and low cost. Note that the wetted coal slurry 766 may be stored conveniently in tanks, similar to those used for heating oil, the use of coal is a lower price alternative to the use of heating oil. Note also that its “pre-wetted” condition will make the use of the coal dust slurry very safe, so that fires or explosions will be eliminated.

For much smaller users, who would like to use low burning rate boilers or furnaces 854, it is possible to use the wetted coal slurry to fill small “packages” so as to form cartridges 850. The casing can be burnable, such as heavy cellophane. These packages would be sufficiently tough to be stacked for use and then placed end to end for a “stoker” type furnace or boiler, so that the feed rate of the filled cartridges 850 can be varied to meet heating needs of the small users heating equipment 854.

At lower right of FIG. 10, a second use for packaging of coal dust slurry 766 is shown at lower right. The filled cartridges 850 are repackaged for decorative burning purposes, as by a corrugated exterior 862 covering the interior filled cartridge from wetted coal 766, so as to form package 856. Note that various minerals may be placed in the corrugated jacket 862 so as to provide interesting colors when burned along with the coal core 870. It would also be practical to include a “fire starter” tube 866 in a recess in the corrugated jacket 862. This could take the form of a capped tube of combustible material, such as jelled Sterno (r), a trade name for jellied denatured alcohol. The user would remove the tube of the fire starter mix 866, remove the cap, and press to “squirt” the flammable contents onto the corrugated cardboard 862, and then light the “squirted patch” with a match. Subsequent coal logs 860 that are added to the fireplace would start from the heat of flames generated by the previous log 860. This combination of corrugated jacket 862 and coal slurry core 870 would form an excellent coal log 860 substitute for use of natural logs, and should be less expensive. The released NH3 would flow up the chimney and would tend to clean the chimney of soot as it passed by, and if desired, other chimney cleaning chemicals can be added to the corrugated jacket 862 to be released during burning.

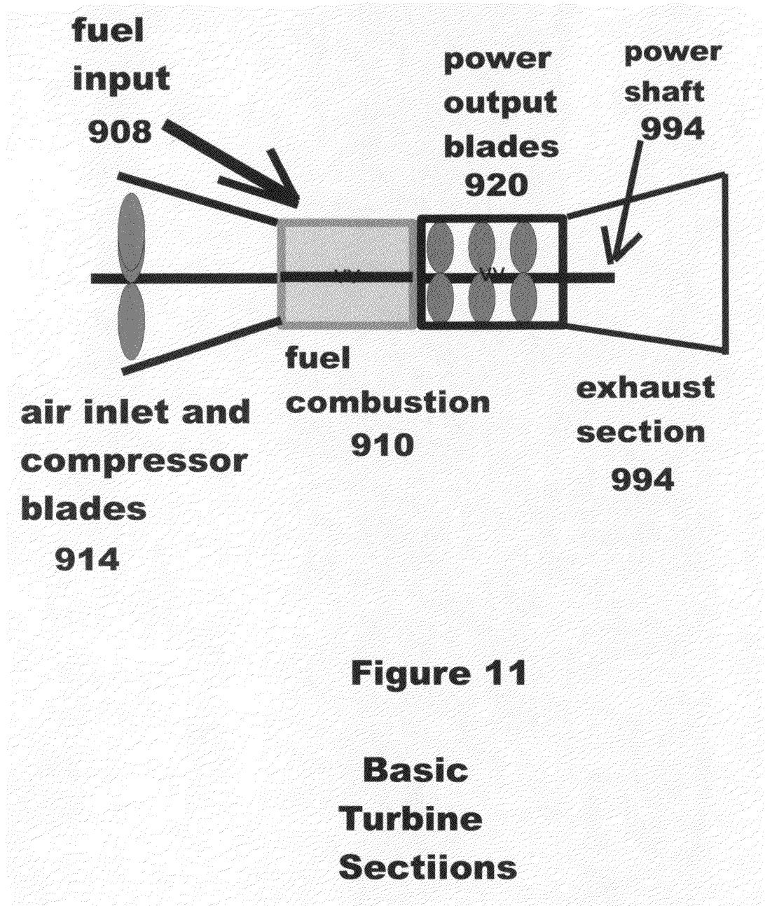

FIG. 11 is a cutaway pictorial of a T130 “Titan” single shaft gas turbine, manufactured by Solar Gas Turbine, of San Diego, Calif. There are five main sections (1) the output shaft and gearbox at lower left, and just to the right is the air intake section. (2) is the compressor blade section, (3) is the combustor chamber with fuel input station, (4) is the turbine section, which when rotating also rotates the single shaft that runs down the length of the T130 turbine, and (5) is the exhaust for waste gasses.

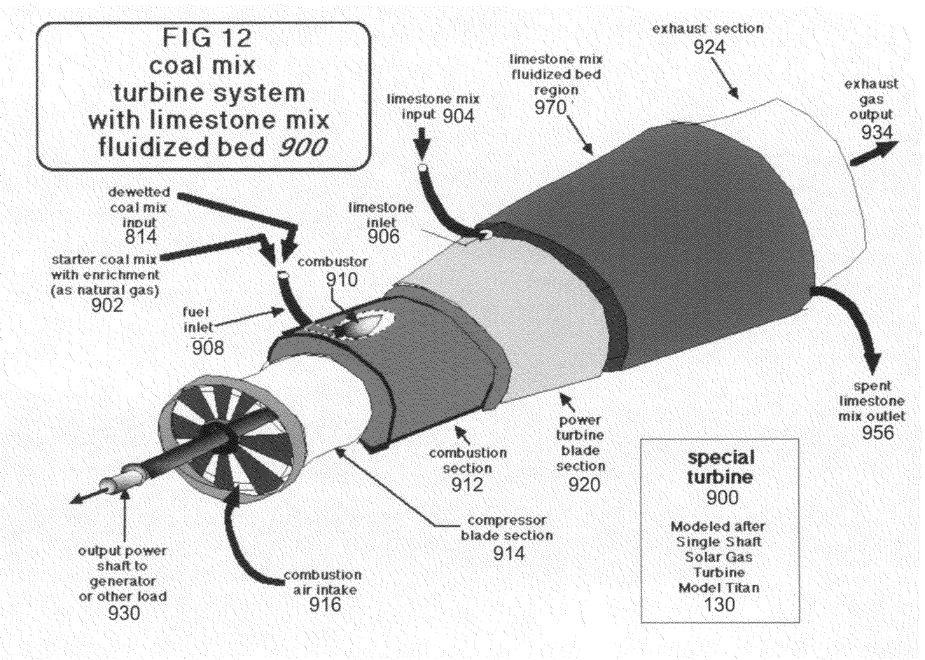

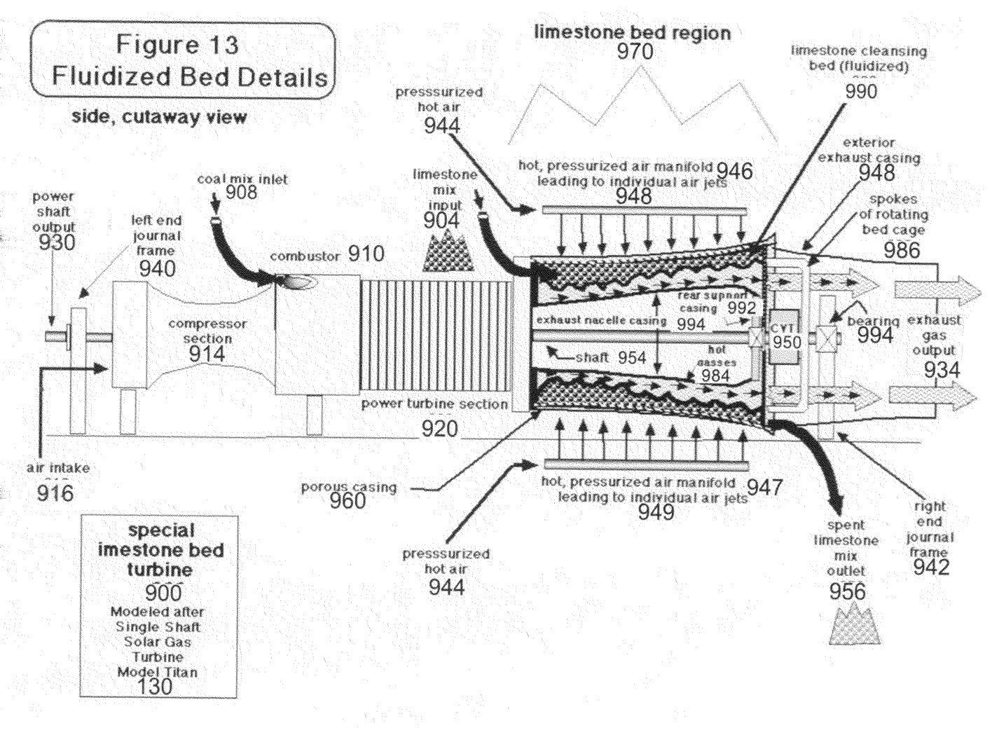

FIG. 12 is a schematic drawing of a special turbine 900, positioned similarly to the cutaway pictorial of the T130 “Titan” Solar Turbine of FIG. 11. Here the power turbine blades section 920 has been specially outfitted with impact resistant metal, as Titanium, so that coal dust (as “de-wetted” coal mix input 814) can be used without harming the power turbine blades 920. While the coal dust 814 is fine grain, perhaps an average size of 0.005 inches, it would have a much more severe scouring effect than is the case when, for example, natural gas alone is used to power the turbine.

As with the T130 turbine of FIG. 1, the special turbine 900 has an output power shaft 930 at lower left, so as to drive an electric power generator, or other mechanical load. Similarly, there is an combustion air intake 916 just behind the output power shaft 930, and just behind the air intake 916 is the “wasp waist” of the compressor blade section 914. At middle left is the fuel inlet 908. Here two fuels may be used, after starting, a “de-wetted” coal dust mix 814 could be used. To start the special turbine 900, it may be necessary to use a more volatile fuel, such as adding a substantial amount of natural gas 902 to the coal dust 814. Once the special turbine has come up to speed and operational temperature, the fuel input to the cumbustor section 910 and cumbustor unit 920 can be switched over to “pure” “de-wetted” coal dust 814.

After combustion in combustion section 912, the hot gasses of combustion expand and rotate the power turbine blades of section 920, which through the single shaft, power the front compressor blade section 914 and furnish output power to the load shaft 930. Note that just “down flow” of the power turbine blade section is the most heavily modified part of special turbine 900, the exhaust and fluidized limestone bed section 924. Herein a limestone and flue gas cleansing mix 904 is introduced to section 924. Inside (not shown here, but will be shown in detail in FIG. 13) is a rotating limestone “bed” that acts to clear out sulfurous compounds released from coal as it is burned in the combustion section 912. Note that the inorganic sulfur was removed at the coal processing site near the mining operation, the organic sulfur remains in the coal and must be removed less sulfurous compounds “go up the stack” into the atmosphere at the power plant. The waste exhaust gasses exit through exhaust section 924, thence to any further waste gas cleaning stations and the usual vent chimney.

Although flat “bubbling limestone” beds are a familiar part of waste gas cleansing at the gas exit of a large power station boiler (as 820 of FIG. 10), rotating limestone beds as 924 have not been used in turbine power plants. The sulfur-cleaned exhaust gas output 934 exits at upper right in FIG. 12.

FIG. 13 details the inner mechanism and design of the fluidized bed region 970 of the special turbine 900. Parts that were not shown in FIG. 12 are, for instance, the left end journal frame 940 which supports the left end of the single shaft 954 of the special turbine 900, which emerges as power shaft output 930 at center left. Also not shown in FIG. 12 was the right end journal frame 942, which supports the right end of the single shaft 954. Bearings on the shaft 954 support the rotating limestone bed 990 which is within the air porous casing 960 of the rotating cage through rear support casing 992. The limestone bed cage 980 rotates around the stationary exhaust nacelle casing 990, creating a waste gas corridor 974 (upper) and 976 (lower) for the hot waste gas to exit across the inner reaches of the limestone bed 970.

As with a flat limestone gas cleaning bed (not shown), the limestone mix 904 should be “fluffed” as by hot air jets, and to this end, the exterior exhaust cage housing 960 is made air porous. At the bottom pressurized hot air 944 is fed to manifold 947 and thence to individual air jets 949 so as to continuously fluff the limestone mix bed 990. The hot air pressure 944 may be varied to improve the fluffing of the limestone mix bed 990.

In a slowly rotating bed, the rotating will shake up the limestone mix 904 when it rotates around, but adding air jets 949 at the bottom for fully fluffing the limestone is critical. But even at the top of the rotating bed, it is advantageous to use air fluffing, as by pressurized air 944 fed to air manifold 946 and thence to individual air jets 948, but here, the air jets are angled to the surface of the rotating porous casing 960, so that “side fluffing” of the limestone bed 970 occurs. The inner surface of the limestone bed cage 980 is formed in a long spiral, so that rotating of the cage 980 tends to urge the limestone mix 904 from the entrance point towards the outlet point for spent limestone mix 956. The speed with which the limestone mix 904 is urged to the exit outlet 956 is governed by the rotation speed of the limestone bed cage 980. This speed is regulated by the continuously variable transmission CVT 950. The specific gear ratio employed by CVT 950 is determined by the absorptivity of the rotating limestone bed 980. The gear ratio of CVT 950 should adjust the speed of urging the limestone mix 904 across the rotating cage 980 so that the sulfur compounds are “just removed” during passage, so as not to waste any of the limestone mix 904. This can be done by intermittent chemical assay, or by “on line” chemical assay of the emerging spent limestone mix 956, in which case the assay station would furnish “speed instructions” to the CVT 950. Cold start conditions would put the rotation of the limestone bed 980 at “stop” or a very low speed until the limestone bed region 970 had reached “full heat” to operational standards, at which time the CVT 950 would operate on instructions furnished by the limestone bed assay station (not shown).

What is claimed:

1. A manufacturing process wherein rock, such as the Oligocene rock serpentine, is fractured without substantial wall grinding pressure in the presence of a pressurized flue gas, such as CO2, so that the flue gas may gain entry into the interior recesses of the fractured rock.

2. A manufacturing process wherein an array of high pressure gas jets serves to sort particles by size so that only smaller particles of a suitable size can emerge from the fracturing operation and the rest continue to be fractured into smaller pieces.

3. A manufacturing process where competing streams of high speed rock particles are mixed so as to reduce their velocity in a compact vessel by comparison to the usual “bag house” which requires much volume and heavy maintenance.

4. A manufacturing process wherein flue gas such as CO2 is preferentially encouraged to enter recently fractured rock by addition of ultrasonic energy without resorting to liquid intermediary substances.

5. A manufacturing process which forms a cementitious coating over the recently fractured rock so as to seal in any sequestered flue gas.

6. A manufacturing process which forms a cementitious coating over the recently fractured rock which makes the coated rock suitable as a valuable building trade byproduct.

7. A coal processing process which employs a rotary collider to provide small particles, nominally of 0.005 inch size, for efficient sorting out of impurities, such as clay and inorganic sulfur.

8. A coal processing process which employs a surfactant and partial ammonia aqueous mixture to coat the coal dust of claim 7, so as to render it less susceptible to fire or explosion.

9. A coal processing process of claim 8, in which the resultant wetted coal dust is readily pumped for transport as by pipeline, rail car, or ship.

10. The wetted coal dust of claim 8 wherein introduced to a separator, as a rotary device, so as to remove a substantial portion of the liquid accompanying the coal dust, thus rendering the “de-wetted” coal dust substantially more flammable when injected into a burner or turbine.

11. The wetted coal dust of claim 8 which is not “de-wetted,” but burned directly, as in a boiler furnace, so that ammonia is released during the burning to complex with nitrous oxide gasses that arise during burning of coal, so as to remove said gasses from the vented exhaust stack.

12. The wetted coal dust of claim 8 which is not “de-wetted” but directly fashioned into small packages, as cylindrical, so as to be easily used for home or other small volume users, as with a stoker furnace wherein the small packages are fed automatically into the burning area.

13. The wetted coal dust of claim 8 which is not “de-wetted,” but fashioned into a core for a coal log for decorative burning, as in a fireplace or patio basin.

14. The decorative coal log of claim 13 wherein minerals are added to the coal log jacket so as to provide attractive colors during the burning of the coal log.

15. The decorative coal log of claim 13 wherein a fire starting promoter tube is furnished with each coal log, as in a recess on the coal log jacket.

16. A power or heat generating turbine in which the usual gaseous fuel is replaced after startup with a powdered coal, as in claim 8.

17. A power or heat generating turbine of claim 16 in which a rotating rock bed, of, for example, limestone such that such bed means are rotated within the exhaust gas stream of the turbine so as provide a fluidized bed which will complex out or otherwise sequester unwanted exhaust gas compounds, as sulfurous compounds, from the gaseous waste products.
